(19) United States
(12) Patent Application Publication
(10) Pub. No.: US 2012/0035814 A1
(43) Pub. Date: Feb. 9, 2012

(54) DEVICE FOR CONTROLLING A DOOR LEAF

(75) Inventor: Jean-Marc Tissot, Viuz en Sallaz (FR)

(73) Assignee: DAV, Creteil Cedex (FR)

(21) Appl. No.: 13/201,886

(22) PCT Filed: Feb. 23, 2010
(86) PCT No.: PCT/FR2010/000164

§ 371 Date: Oct. 27, 2011

(30) Foreign Application Priority Data
Feb. 23, 2009 (FR) 09/00804

(51) Int. Cl. E05F 15/20; B60J 3/02; B60J 7/02; B60J 5/00

(52) U.S. Cl. 701/49

(57) ABSTRACT

The invention relates to a device for controlling a door leaf (3) of a passenger compartment, in particular of an automobile, comprising: a detection field formed on at least one active surface of the door leaf (3); a unit (5) for detecting a gesture of a user on said active surface; and an interpretation module (7) for generating a command relating to the door leaf (3) and associated with the detected gesture.

The present invention relates to a device for controlling an opening element, in particular of a motor vehicle.

Currently, motor vehicles are increasingly provided with items of equipment that are electronically controlled and provide many services to the driver.

The control of all these items of equipment requires control members actuated by the driver such as switches or buttons, levers or joysticks situated in the driver's immediate environment.

The multitude of functions to be controlled gives rise to a multiplicity of these control members. This growing number of control members may make it more complex for the driver to understand all the controls and causes many hand movements for the driver to reach a precise control, thus reducing driving safety.

Moreover, a control member for opening/closing an opening element is known for example from document JP2007321446 proposing predefined positions of the opening element. However, these predefined positions do not always correspond to the position desired by the user.

On the contrary, to reach a precise position, the driver is forced to actuate the control member in a continuous manner, which reduces his attention on the road and further reduces driving safety.

The object of the invention is therefore to alleviate these drawbacks of the prior art by proposing a device for controlling an opening element making it possible to simplify the controls by reducing the quantity of control members to be operated and by improving consistency between the accessibility of the control and the item of equipment controlled.

A further object of the invention is to increase the precision of the controls of the opening element while ensuring optimal safety.

Accordingly, the subject of the invention is a device for controlling an opening element of a dwelling place, in particular of a motor vehicle, characterized in that it comprises: a detection field defined on at least one active surface of the opening element, a detection unit for detecting a hand action of a user on said active surface, and an interpretation module for generating at least one command, relating to the opening element, associated with the detected hand action.

The control device according to the invention may also comprise one or more of the following features, taken separately or in combination:
said active surface of the opening element is a glazed surface;
the detection field is defined on a face of said active surface of the opening element, said surface being directed toward the inside of the dwelling place;
the detection field is defined on a face of said active surface of the opening element, said surface being directed toward the outside of the dwelling place;
the detection unit comprises at least two ultrasound sensors;
the detection unit comprises a tactile sensor making it possible to detect the pressure of the hand action of the user on said active surface of the opening element;
said device comprises a means for disabling said command when the detected pressure is outside a predefined pressure range;
the interpretation module makes it possible to generate two commands relating to the opening element, said commands being associated with a combined hand action of the user;
the interpretation module makes it possible to generate a command for movement of the opening element, said command being associated with the detected hand action of the user;
said detected hand action is the user's pressure on said active surface of the opening element;
the length of movement of the opening element is associated with the position of the user's pressure on said active surface of the opening element;
said detected hand action is a movement of the user on said active surface of the opening element;
the interpretation module exploits the resultant outcome of the user's movement on said active surface of the opening element substantially parallel to the direction of movement of the opening element;
said command allows the movement of the opening element in a direction corresponding to the direction of movement of the user on said active surface of the opening element;
the length of movement of the opening element is associated with the length of movement of the hand action of the user on the opening element;
the interpretation module makes it possible to generate a command for changing properties of the opening element;
said command is associated with a movement of the user on said active surface of the opening element in a direction substantially perpendicular to the direction of movement of the opening element;
a movement of the user in a first direction is associated with a command to reduce the properties of the opening element, a movement of the user in a second direction is associated with a command for increasing the properties of the opening element, preferably, the quantity of change of properties of the opening element is associated with the length of travel of the movement of the user on said active surface of the opening element;
said device comprises an auxiliary tactile surface allowing a command relative to the opening element.

Other features and advantages of the invention will emerge from the following description given as an example, with no limiting character, with respect to the appended drawings in which:

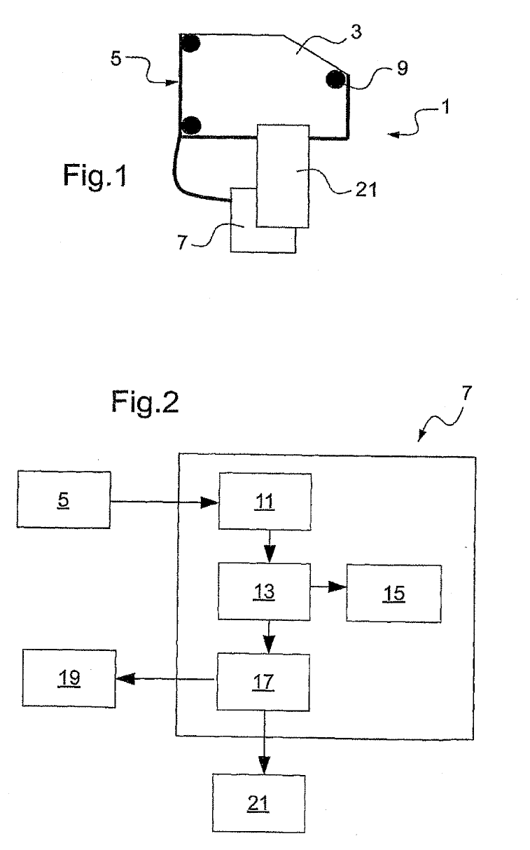

FIG. 1 illustrates a device for controlling an opening element according to the invention,

FIG. 2 is a schematic representation of the control device,

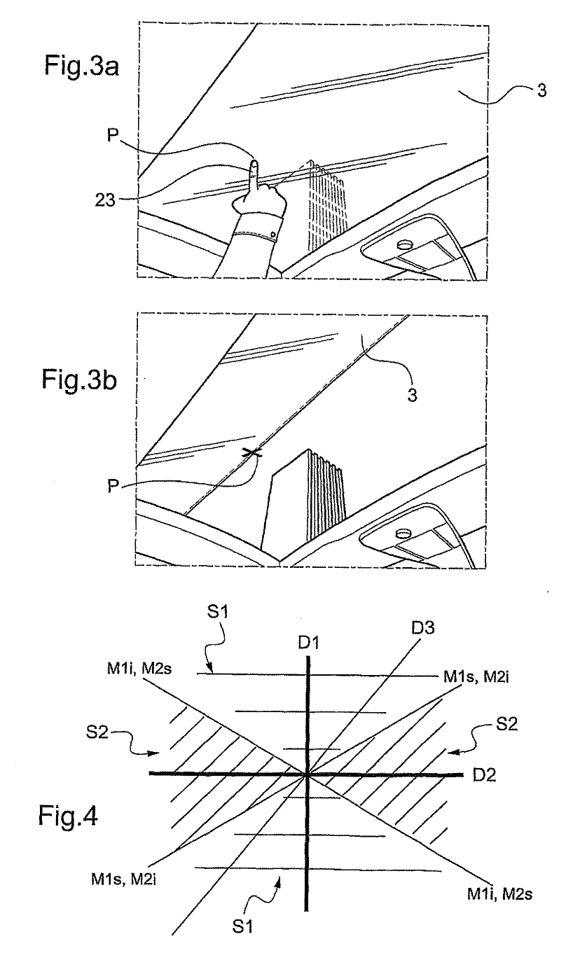

FIGS. 3a and 3b illustrate an exemplary embodiment of a command relating to the opening element, and

FIG. 4 represents an example of interpretation of a movement of the user.

FIG. 1 represents a control device 1 for an opening element 3, for example a sliding element, of a dwelling place, in particular of a motor vehicle. This opening element 3 may comprise a glazed surface, such as a door window, a sunroof or else a windshield. Naturally, the invention could equally apply to an opening element 3 of any dwelling place, such as a garage or a house.

According to the invention, this control device 1 comprises:
a detection field for detecting a hand action of a user, said detection field being defined on at least one active surface of the opening element 3,
a detection unit 5 for detecting a hand action of a user on the active surface of the opening element 3, and
an interpretation module 7 for generating a command, relating to the opening element 3, associated with the detected hand action.

“Active surface” means a surface on which the user can make a hand movement in order to generate a command relating to the opening element 3; this active surface may be a small portion of the opening element 3 or else the whole opening element 3.

The detection field is defined on a face of the active surface of the opening element 3 directed toward the inside of the dwelling place, so as to prevent a command generated by an unauthorized person from the outside of the dwelling place of the vehicle, or even an intrusion into the dwelling place.

A detection field defined on a face of the active surface of the opening element 3 could nevertheless be provided directed toward the outside, for example for a fuel filler cap. In this case, the control device 1 interacts with a means for identifying the user, such as an identification badge.

The user, usually the driver, may make hand movements of different categories on the active surface of the opening element 3. It is possible to cite as an example a pressure in order to indicate a precise point on the active surface of the opening element 3 corresponding to a position of the opening element 3, or else movements for example in translation.

In order to prevent confusion concerning the command desired by the user, the control device 1 interprets a hand movement as a movement when it is made over a distance, for example of at least 5 mm, on the active surface of the opening element 3.

To make such a hand movement, the driver may use his finger, a stylus or any other similar tool. It is also possible to provide for the user to furnish himself with a glove.

Thus, the opening element 3 to be controlled becomes a direct control interface for the user for example in the event of a failure of a control member related to the opening element. The opening element may also serve as a main control interface for the user who no longer uses the related control member.

In order to detect the user's hand movement, the detection unit 5 may comprise optical sensors (camera, laser), surface wave sensors, acoustic wave sensors, and resistive or else capacitive sensors. Since these sensors are known per se to those skilled in the art, they will not be described in greater detail in the present document.

The detection unit 5 may comprise sensors making it possible to detect the contact of the user's finger on the active surface of the opening element 3 in order to extract, for example, the location thereof in coordinates, or else a movement.

According to one embodiment, the detection unit 5 comprises at least two ultrasound sensors 9, of the piezoelectric type. These sensors 9 are for example arranged at the corners of the active surface 3.

Each piezoelectric sensor 9 can make it possible to detect the direction of an acoustic wave reflected for example by the user's finger on the active surface of the opening element 3 which then serves as an acoustic interface for propagating the acoustic wave. In the example illustrated, the control device 1 comprises three sensors 9. In this configuration, the distance between each sensor 9 is known.

More precisely, a first sensor 9 makes it possible to determine its distance from the point of contact of the user on the active surface, and a second sensor 9 similarly makes it possible to determine its distance from the point of contact. Knowing the distance between these two sensors 9, the position of the point of contact is determined by triangulation.

A third sensor 9 makes it possible to increase the accuracy of the location of the hand movement on the active surface of the opening element 3, for example when the user's hand movement is at a distance from the first and second sensors 9 and is closer to the third sensor 9.

Naturally, the active surface may be glazed and in this case, the sensors 9 may comprise a transparent layer made of indium tin oxide, better known as “ITO”.

Moreover, the detection unit 5 makes it possible to gather other data concerning the user's hand movement on the active surface of the opening element 3, notably the pressure exerted at the time of the user's hand movement. For this, it is possible to provide that the detection unit 5 comprises a tactile sensor, for example of the FSR type for “Force Sensing Resistor” using pressure-sensitive resistors. By exerting a pressure on the FSR sensor, its ohmic resistance reduces, thus making it possible, by the application of an appropriate voltage, to measure the pressure applied.

In the case of a glazed active surface, so as not to hamper the user's visibility, the tactile sensor is a transparent layer comprising a translucent resistive film bonded to the opening element 3.

Moreover, the detection unit 5 transmits to the interpretation module 7 at least one item of data from a set of data representative of the detected hand movement, comprising for example a parameter representative of the category of the hand movement (pressure, movement), a parameter representative of the location of the hand movement, a parameter representative of the direction of the movement, a parameter representative of the line of the movement, a parameter representative of the length of the movement, a parameter representative of the pressure of the user's detected hand movement.

According to an exemplary embodiment illustrated in simplified manner by FIG. 2, the interpretation module 7 comprises at least one receiver 11 for receiving all of the data transmitted by the detection unit 5, at least one comparator 13, at least one storage means 15, and at least one controller 17.

Initially, in order to verify whether a command associated with the detected hand movement must be executed, the comparator 13 may compare the parameter representative of the pressure with predefined reference parameters representing the lower and upper limits of an admissible range of hand-movement pressure on the active surface of the opening element 3. These reference parameters are for example stored in the storage means 15.

Thereafter, the comparator 13 can deliver an item of information indicating whether the pressure of the hand movement applied to the active surface is or is not within this admissible range to the controller 17, which transmits this item of information to a means 19 for disabling the control device 1.

If the delivered information indicates that the detected pressure is not included in this admissible range, the disabling means 19 then transmits a disabling signal to an execution module 21 of the control device 1 in order to prevent the module 21 from executing a command associated with the user's hand movement.

This measurement of the pressure of the hand movement makes it possible to prevent account being taken of the user's hand movements that are unintentional or do not relate to the control of the opening element 3, for example scratching in order to clean the opening element 3, striking with the elbow or brushing past.

Naturally, other criteria may be taken into account for allowing or disallowing the execution of a command of the opening element 3, such as the detection of the face of the opening element on which a hand movement is made.

On the contrary, if the delivered information indicates that the detected pressure is included in this admissible range, the command is authorized. The interpretation module 7 generates the associated command and then transmits it to the execution module 21.

For this, it is possible to provide that the storage means 15 comprises a library in which commands relating to the opening element 3 are stored associated with reference data comprising for example parameters representative of hand movements. The comparator 13 compares the data received by the receiver 11 with these reference data and transmits to the controller 17 an item of information concerning the command to be generated. Finally, the controller 17 generates the command associated with the detected hand movement and transmits it to the execution module 21.

The command transmitted to the execution module 21 may be any command relating to the opening element 3, such as a change of properties, for example optical properties, or a movement.

It is possible to also provide a combined hand movement of the user on the active surface of the opening element 3, associated with a double command, for example both for changing of properties and for movement. This combined hand movement may comprise a pressure and a movement or else two movements, for example in different directions.

FIGS. 3a, 3b illustrate an exemplary embodiment of a command for moving the opening element 3. More particularly, it involves commanding the opening, the closure of the opening element 3 which thus moves between at least one opening position and one closure position, and any position in between.

FIG. 3a shows a sunroof 3 in the closed position on which the user places his finger 23 in order to apply a pressure at a precise point P corresponding to a position of this sunroof 3.

As can be seen in FIG. 3b, following this pressure, the sunroof 3 is moved to an open position corresponding to the position of the point P.

The sunroof 3 then reaches a precise position which corresponds to the desire of the user. Thus, the user does not need to concentrate for a long period in order to control the movement of the sunroof 3.

The user may also command the movement of the opening element 3 by making a hand movement implying a movement.

For a more intuitive command, it is possible to associate a movement in a direction substantially parallel to the direction of movement of the opening element 3, with a command to move this glazed surface 3.

For example, when the user's hand movement on the active surface of the opening element 3 is a movement in a first direction, for example from back to front for the user, the associated command is a movement toward the closed position. Similarly, when the user's hand movement on the active surface of the opening element 3 is a movement, in a second opposite direction, in this instance from front to back for the user, the associated command is a movement to the open position. The interpretation module 7 therefore also makes use of the direction of the hand movement made on the active surface of the opening element 3 so that the command allows the movement of the opening element 3 in the same direction as the user's hand movement.

However, when driving, the user's movement may not be parallel to the direction. In this case, the interpretation module 7 exploits the resultant outcome of the user's hand movement on the active surface of the opening element 3 parallel to the direction of movement of the opening element 3.

Thus, irrespective of the direction of movement of the user, the interpretation module 7 considers that the movement is parallel to the direction of movement of the opening element 3.

The interpretation module 7 may also exploit the length of the user's hand movement on the active surface of the opening element 3 so that the length of movement of the opening element 3 is associated with the length of movement of the user's hand movement on the active surface of the opening element 3.

For this, it is possible to provide that the interpretation module 7 comprises a library in which are stored the cross references between the lengths of hand movements and the lengths of movement of the opening element 3 to be controlled.

However, it may also be that the driving conditions do not allow the user to make movements of a precise length. To correspond as well as possible to the user's expectations, it is possible to provide that each movement of the user (irrespective of the length) corresponds to a given length of movement of the opening element 3. The user than does not need to reflect on the movement that he is making and remains concentrated on the road.

Another example of a command is a command for changing properties of the opening element 3.

According to one embodiment, the command for changing properties relates to changing the opaqueness/transparency of the opening element 3. In this case, the opening element 3 is electrochromatic, and the interpretation module 7 transmits a command to the execution module 21 making it possible to apply an electric voltage to the opening element 3 in order to change the opaqueness/transparency of the opening element 3, the voltage to be applied (sign, value) being determined by the interpretation module 7 with respect to the hand movement detected by the detection unit 5.

For example, a command for changing properties is associated with a movement of the user on the active surface of the opening element 3 in a direction substantially perpendicular to the direction of movement of the opening element 3. Naturally, this command for changing properties could also be associated with a pressure of the user on the active surface of the opening element 3 or else with a movement in another direction.

As above, in order to make up for a movement of the user that is imprecise while driving, the interpretation module 7 exploits the resultant outcome of the user's movement on the active surface of the opening element 3 perpendicular to the direction of movement of the opening element 3.

Moreover, the interpretation module 7 exploits the direction of movement made on the opening element 3.

In particular, if the command for changing properties relates to changing the opaqueness/transparency of the opening element 3, it is possible to provide that a movement, in a first direction, for example from left to right for the user, increases the opaqueness of the opening element 3, and that a movement in a second opposite direction, in this instance from right to left, reduces this opaqueness.

The interpretation module 7 may also exploit the length of the user's movement on the opening element 3 so that the longer a movement is, the more or less opaque the opening element 3 becomes.

In the situation in which several commands relating to the opening element 3 can be carried out, an association of a command with a direction could for example be provided.

For example, with reference to FIG. 4, in the situation in which two directions D1, D2 are associated respectively with one command, it is possible to provide for each direction D1, D2 admissible sectors delimited by the straight lines (M1i, M1s) and (M2i, M2s).

Thus the first sectors S1 illustrated with horizontal hash marks, delimited by the straight lines (M1i, M1s) represent the admissible sectors for a movement command, and the second sectors S2 illustrated by diagonal hash marks, delimited by the straight lines (M2i, M2s) represent the admissible sectors for a command for changing opaqueness for example.

Thus, if the straight line D3, representing the direction of movement of the user, is included in a first sector S1 illustrated with horizontal hash marks, the interpretation module 7 generates a movement command. On the other hand, if it is in a second sector S2 illustrated with diagonal hash marks, the interpretation module 7 generates a command for changing properties.

Moreover, the control device 1 may comprise an auxiliary tactile surface allowing a command relating to the opening element 3, such as for example the movement or the variation of opaqueness.

This auxiliary tactile surface may be close to the opening element 3 to be controlled, such as for example a top corner of a windshield, but may also be a tactile surface arranged in the driver's immediate environment, for example on the central control or else directly on the steering wheel.

This auxiliary tactile surface makes it possible to control the movement of the opening element 3 when the latter is in a wide open position and no longer has a zone that can be accessed by the user.

However, it would also be possible to provide for the opening element 3 to have a stop so as to limit its movement and allow a zone of the opening element 3 to be always accessible to the user.

It is therefore understood that such a control device allows a more intuitive control for the user and lets him stay concentrated on the road while driving. Moreover, since the opening element 3 is directly the user's control interface, the commands carried out correspond exactly to what the user desires.

1. A device for controlling an opening element of a motor vehicle, comprising:
a detection field defined on at least one active surface of the opening element;
a detection unit for detecting a hand action of a user on said at least one active surface; and
an interpretation module for generating at least one command, relating to the opening element, based on the detected hand action.

2. The device as claimed in claim 1, wherein said active surface of the opening element is a glazed surface.

3. The device as claimed in claim 1, wherein the detection field is defined on a face of said at least one active surface of the opening element, said at least one active surface being directed toward the inside of the motor vehicle.

4. The device as claimed in claim 1, wherein the detection field is defined on a face of said at least one active surface of the opening element, said at least one active surface being directed toward the outside of the motor vehicle.

5. The device as claimed in claim 1, wherein the detection unit comprises at least two ultrasound sensors.

6. The device as claimed in claim 1, wherein the detection unit comprises a tactile sensor for detecting a pressure of the hand action of the user on said at least one active surface of the opening element.

7. The device as claimed in claim 6, wherein said device comprises means for disabling said at least one command when the detected pressure is outside a predefined pressure range.

8. The device as claimed in claim 1, wherein the interpretation module generates two commands relating to the opening element, said two commands being associated with a combined hand action of the user.

9. The device as claimed in claim 1, wherein the interpretation module generates a command for movement of the opening element, said command being associated with the detected hand action of the user.

10. The device as claimed in claim 9, wherein said detected hand action is the user applying pressure on said at least one active surface of the opening element.

11. The device as claimed in claim 10, wherein a length of movement of the opening element is associated with the position of the applied pressure on said at least one active surface of the opening element.

12. The device as claimed in claim 9, wherein said detected hand action is a movement of the user on said at least one active surface of the opening element.

13. The device as claimed in claim 12, wherein the interpretation module exploits a resultant outcome of the user's movement on said at least one active surface of the opening element substantially parallel to a direction of movement of the opening element.

14. The device as claimed in claim 12, wherein said at least one command allows movement of the opening element in a direction corresponding to the direction of movement of the user on said at least one active surface of the opening element.

15. The device as claimed in claim 12, wherein a length of movement of the opening element is associated with a length of movement of the hand action of the user on the opening element.

16. The device as claimed in claim 1, wherein the interpretation module generates a command for changing properties of the opening element.

17. The device as claimed in claim 16, said command is associated with a movement of the user on said at least one active surface of the opening element in a direction substantially perpendicular to a direction of movement of the opening element.

18. The device as claimed in claim 17, wherein:
a movement of the user in a first direction is associated with a command to reduce the properties of the opening element,
a movement of the user in a second direction is associated with a command for increasing the properties of the opening element, and
a quantity of change of properties of the opening element is associated with a length of travel of the movement of the user on the opening element.

19. The device as claimed in claim 1, further comprising an auxiliary tactile surface allowing a command relative to the opening element.
